(19) United States
(12) Patent Application Publication
(10) Pub. No.: US 2023/0036883 A1
(43) Pub. Date: Feb. 2, 2023

(54) MOTOR CONTROL DEVICE, MOTOR, DRIVE APPARATUS, MOTOR CONTROL METHOD, AND MOTOR CONTROL PROGRAM

(71) Applicant: NIDEC CORPORATION, Kyoto (JP)

(72) Inventors: Akihiro NITA, Kyoto (JP); Junya YAMADA, Kyoto (JP)

(21) Appl. No.: 17/868,818

(22) Filed: Jul. 20, 2022

(30) Foreign Application Priority Data
Jul. 21, 2021 (JP) 2021-120963

(51) Int. Cl. H02P 21/22; H02K 9/19; H02K 11/27; H02K 11/25; H02P 21/20

(52) U.S. Cl. CPC H02P 21/22; H02K 9/19; H02K 11/27; H02K 11/25; H02P 21/20

(57) ABSTRACT

A control unit executes first current control for controlling a d-axis current component and a q-axis current component of a current to be supplied to a motor, second current control for controlling the d-axis current component and the q-axis current component based on a heating value target value related to a heating value generated in the motor and setting a ratio of the d-axis current component to the q-axis current component to be different from the ratio in the first current control, and vibration suppression control to be executed when the second current control is executed, and adds a first periodic signal to the torque target value in the vibration suppression control. A phase of the first periodic signal is shifted from a phase in a waveform of an output torque of the motor output when the second current control is executed without executing the vibration suppression control.

### CROSS-REFERENCE TO RELATED APPLICATIONS

The present invention claims priority under 35 U.S.C. § 119 to Japanese Patent Application No. 2021-120963 filed on Jul. 21, 2021, the entire content of which is incorporated herein by reference.

### FIELD OF THE INVENTION

The present invention relates to a motor control device, a motor, a drive apparatus, a motor control method, and a motor control program.

### BACKGROUND

A method for controlling a current to be supplied to a motor by dividing the current into an excitation current and a torque current has been known. For example, there is conventionally known a method for increasing a heating value of a motor by changing a ratio between an excitation current and a torque current when warming capability is insufficient.

When control for increasing a heating value in the motor by changing a ratio of the excitation current to the torque current is performed as described above, vibration caused in the motor may increase due to a change in balance between the excitation current and the torque current.

### SUMMARY

One aspect of an exemplary motor control device of the present invention includes a control unit that controls a motor based on a torque target value. The control unit is capable of executing first current control for controlling a d-axis current component and a q-axis current component of a current to be supplied to the motor, second current control for controlling the d-axis current component and the q-axis current component based on a heating value target value related to a heating value generated in the motor and setting a ratio of the d-axis current component to the q-axis current component to be different from the ratio in the first current control, and vibration suppression control to be executed when the second current control is executed, and adds a first periodic signal to the torque target value in the vibration suppression control. A phase of the first periodic signal is shifted from a phase in a waveform of an output torque of the motor output when the second current control is executed without executing the vibration suppression control.

One aspect of an exemplary motor of the present invention includes the above-described motor control device.

One aspect of an exemplary drive apparatus of the present invention is a drive apparatus that rotates an axle of a vehicle, and the drive apparatus includes the motor, and a transmission mechanism that transmits rotation of the motor to the axle.

One aspect of an exemplary motor control method of the present invention is a motor control method for controlling a motor based on a torque target value. The motor control method includes executing first current control for controlling a d-axis current component and a q-axis current component of a current to be supplied to the motor, executing second current control for controlling the d-axis current component and the q-axis current component based on a heating value target value related to a heating value generated in the motor and setting a ratio of the d-axis current component to the q-axis current component to be different from the ratio in the first current control, executing vibration suppression control to be executed when the second current control is executed, and adding a first periodic signal to the torque target value in the vibration suppression control. A phase of the first periodic signal is shifted from a phase in a waveform of an output torque of the motor output when the second current control is executed without executing the vibration suppression control.

One aspect of an exemplary recording medium recording a motor control program of the present invention causes a computer to execute the motor control method described above.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a block diagram illustrating a configuration of a drive apparatus according to a first embodiment;

FIG. 2 is a block diagram illustrating functions of a control unit according to the first embodiment;

FIG. 3 is a graph representing a relationship between a d-axis current component, a q-axis current component, and an output torque;

FIG. 4 is a graph representing a first sine wave and a first periodic signal in the first embodiment;

FIG. 5 is a flowchart illustrating a control procedure by the control unit of the first embodiment;

FIG. 6 is a flowchart illustrating a control procedure by the control unit in a second current control mode of the first embodiment;

FIG. 7 is a block diagram illustrating functions of a control unit according to a second embodiment;

FIG. 8 is a flowchart illustrating a control procedure by the control unit in a second current control mode of the second embodiment;

FIG. 9 is a graph representing a result of an example of the first embodiment; and

FIG. 10 is a graph representing a result of an example of the second embodiment.

### DETAILED DESCRIPTION

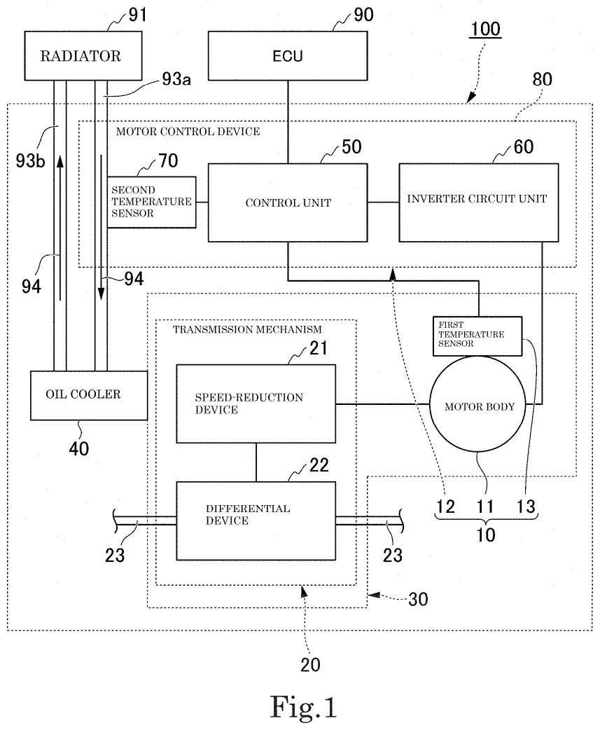

A drive apparatus 100 illustrated in FIG. 1 is a drive apparatus that is mounted on a vehicle to rotate an axle 23 of the vehicle. As illustrated in FIG. 1, the drive apparatus 100 includes a motor 10, a transmission mechanism 20, a housing 30, and an oil cooler 40. The transmission mechanism 20 is a device that transmits the rotation of the motor 10 to the axle 23. The transmission mechanism 20 includes a speed-reduction device 21 connected to the motor 10 and a differential device 22 connected to the speed-reduction device 21. The differential device 22 rotates the axle 23.

Although not illustrated, oil is contained in the housing 30. The oil in the housing 30 is used for cooling the motor 10 and lubricating the transmission mechanism 20 and the like. The oil in the housing 30 is cooled by the oil cooler 40. The oil cooler 40 is connected to a radiator 91 mounted on the vehicle by pipes 93a and 93b. A refrigerant 94 flows inside the pipes 93a and 93b. The refrigerant 94 is, for example, water. The refrigerant 94 cooled by the radiator 91 flows through the pipe 93a and flows to the oil cooler 40. The refrigerant 94 flowed to the oil cooler 40 cools the oil by heat exchange with the oil in the housing 30. The refrigerant 94 flowed to the oil cooler 40 flows through the pipe 93b, returns to the radiator 91, and is cooled again. The warming of the vehicle on which the drive apparatus 100 of the present embodiment is mounted is performed by heating air in the vehicle with the refrigerant 94 warmed by the heat of the motor 10.

The motor 10 includes a motor body 11, a motor control device 12, and a first temperature sensor 13. Although not illustrated, the motor body 11 includes a rotor connected to the speed-reduction device 21 and a stator facing the rotor with a gap interposed therebetween. The rotor of the motor body 11 has, for example, eight magnetic poles arranged along a circumferential direction. That is, in the present embodiment, the motor 10 is an 8-pole motor. The number of magnetic poles of the motor 10 is not particularly limited. The motor body 11 and the transmission mechanism 20 are contained in the housing 30. The first temperature sensor 13 is a sensor capable of measuring a temperature of the motor body 11. The first temperature sensor 13 is attached to, for example, a coil in the stator of the motor body 11.

The motor control device 12 is electrically connected to the coil of the stator (not illustrated) of the motor body 11. Power is supplied from the motor control device 12 to the coil of the motor body 11. The rotation of the rotor (not illustrated) of the motor body 11 is controlled by the motor control device 12. The motor control device 12 includes a control unit 50, an inverter circuit unit 60, a second temperature sensor 70, and a case 80.

The control unit 50, the inverter circuit unit 60, and the second temperature sensor 70 are contained in the case 80. The case 80 is attached to the housing 30, for example. At least a part of the case 80 and at least a part of the housing 30 may be a part of the same single member. A part of the pipe 93a passes through the inside of the case 80. The control unit 50 and the inverter circuit unit 60 are cooled by the refrigerant 94 flowing in the pipe 93a. A part of the pipe 93a may be formed by a part of the case 80. The second temperature sensor 70 is a sensor capable of measuring a temperature of the refrigerant 94 passing through the case 80.

The inverter circuit unit 60 is electrically connected to the motor body 11. The inverter circuit unit 60 adjusts power to be supplied to the coil of the motor body 11 based on a signal from the control unit 50. Although not illustrated, the inverter circuit unit 60 includes a plurality of switching circuits.

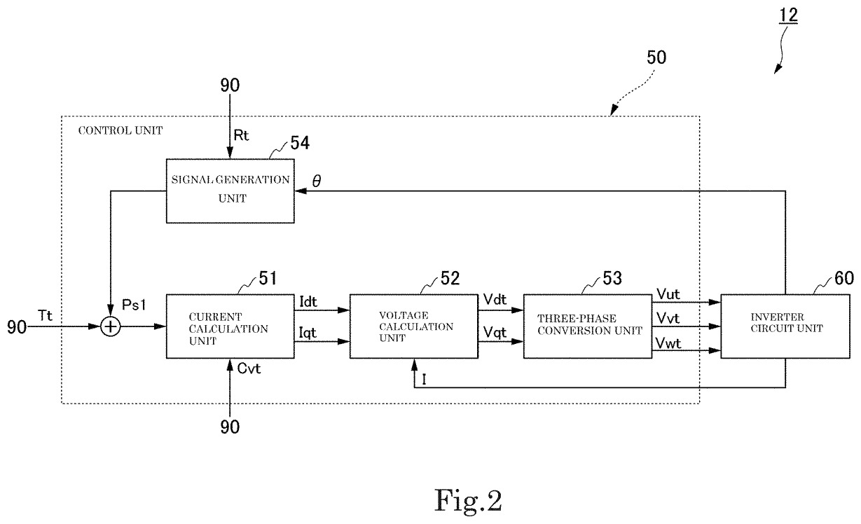

The control unit 50 controls the motor 10 based on a signal input from an electronic control unit (ECU) 90 mounted on the vehicle. The ECU 90 is a vehicle control device that controls various devices mounted on the vehicle. As illustrated in FIG. 2, in the present embodiment, the signal input from the ECU 90 to the control unit 50 includes a torque target value Tt, a rotation speed target value Rt, and a heating value target value Cvt. The control unit 50 controls the motor 10 by performing vector control for controlling a current I to be supplied to the motor 10 separately for a d-axis current component Id and a q-axis current component Iq. In the present embodiment, the current I to be supplied to the motor 10 is a three-phase alternating current.

The d-axis current component Id is a component of the current I in a d-axis direction in the motor body 11. The q-axis current component Iq is a component of the current I in a q-axis direction in the motor body 11. The d-axis direction is a direction of a magnetic flux generated by magnetic poles of the rotor of the motor body 11. The q-axis direction is a direction electrically and magnetically orthogonal to the d-axis direction. In the motor body 11, the d-axis direction is, for example, a radial direction passing through a center of a magnetic pole in a circumferential direction. In the motor body 11, the q-axis direction is, for example, a radial direction passing through centers of magnetic poles adjacent in the circumferential direction. The d-axis current component Id is a current component that generates a magnetic flux. The q-axis current component Iq is a component that generates torque.

The control unit 50 includes a current calculation unit 51, a voltage calculation unit 52, a three-phase conversion unit 53, and a signal generation unit 54. The current calculation unit 51 calculates a target value Idt of the d-axis current component and a target value Iqt of the q-axis current component. The target value Idt of the d-axis current component and the target value Iqt of the q-axis current component calculated by the current calculation unit 51 are input to the voltage calculation unit 52. In second current control to be described later, a heating value target value Cvt is input from the ECU 90 to the current calculation unit 51.

The voltage calculation unit 52 calculates a target value Vdt of the d-axis voltage component and a target value Vqt of the q-axis voltage component based on the target value Idt of the d-axis current component and the target value Iqt of the q-axis current component calculated by the current calculation unit 51. In the present embodiment, the voltage calculation unit 52 performs feedback control by using the current I input from the inverter circuit unit 60, and calculates the target value Vdt of the d-axis voltage component and the target value Vqt of the q-axis voltage component. The voltage calculation unit 52 biaxially converts the input three-phase current I into the d-axis current component Id and the q-axis current component Iq. The voltage calculation unit 52 performs feedback control by using a value of each current component obtained by the biaxial conversion, and calculates each voltage component. The target value Vdt of the d-axis voltage component and the target value Vqt of the q-axis voltage component calculated by the voltage calculation unit 52 are input to the three-phase conversion unit 53.

The three-phase conversion unit 53 converts the input target values of the two-axis voltage components into target values of three-phase voltage components. In the present embodiment, the three-phase conversion unit 53 converts the target value Vdt of the d-axis voltage component and the target value Vqt of the q-axis voltage component into a target value Vut of a U-phase voltage component, a target value Vvt of a V-phase voltage component, and a target value Vwt of a W-phase voltage component. The target value Vut of the U-phase voltage component, the target value Vvt of the V-phase voltage component, and the target value Vwt of the W-phase voltage component converted by the three-phase conversion unit 53 are input to the inverter circuit unit 60. The inverter circuit unit 60 generates three-phase current I based on the input target values of the three-phase voltage components, and supplies the three-phase current I to the motor body 11.

The signal generation unit 54 generates a first periodic signal Ps1 to be described later. The first periodic signal Ps1 generated by the signal generation unit 54 is added to the torque target value Tt input to the current calculation unit 51 when vibration suppression control to be described later is executed. An electrical angle θ of the motor 10 is input from the inverter circuit unit 60 to the signal generation unit 54. The rotation speed target value Rt of the motor 10 is input from the ECU 90 to the signal generation unit 54.

A motor control method of the present embodiment is executed by the control unit 50. The control unit 50 can execute first current control, second current control, and vibration suppression control. The first current control is current control for controlling the three-phase current I to be supplied to the motor 10 usually. The first current control is vector control for controlling the d-axis current component Id and the q-axis current component Iq of the current I to be supplied to the motor 10. In the first current control, the control unit 50 controls the value of the d-axis current component Id and the value of the q-axis current component Iq to values having the highest energy efficiency.

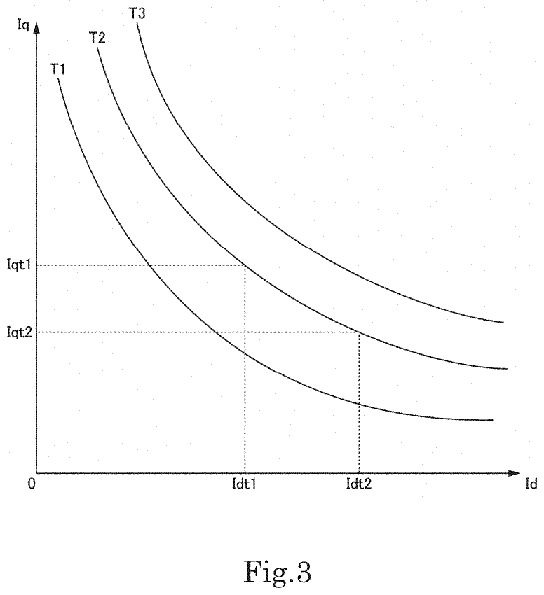

FIG. 3 is a graph representing a relationship between the d-axis current component Id, the q-axis current component Iq, and an output torque To of the motor 10. In FIG. 3, a vertical axis represents the q-axis current component Iq, and a horizontal axis represents the d-axis current component Id. A plurality of hyperbolas illustrated in FIG. 3 are equal torque curves. FIG. 3 illustrates an equal torque curve when the output torque To is T1, an equal torque curve when the output torque To is T2, and an equal torque curve when the output torque To is T3. When the value of the d-axis current component Id and the value of the q-axis current component Iq are controlled to values on the equal torque curve of the desired output torque To, the desired output torque To can be output.

In the first current control, based on the relationship represented in FIG. 3, the control unit 50 sets the value of the d-axis current component Id and the value of the q-axis current component Iq to values at which the energy of the current I is the smallest within a range in which the desired output torque To can be output. Specifically, in the first current control, the current calculation unit 51 of the control unit 50 calculates, as the target value of each current component, a value at which a product of the value of the d-axis current component Id and the value of the q-axis current component Iq is the smallest from among the values of the current components on the equal torque curve of the input torque target value Tt. In other words, in the first current control, the current calculation unit 51 calculates, as the target value of each current component, a value of each current component at which a distance from an origin to the equal torque curve of the torque target value Tt is the shortest in the graph of FIG. 3. For example, when the value of the torque target value Tt is T2, in the first current control, the current calculation unit 51 calculates the target value Idt of the d-axis current component as Idt1, and calculates the target value Iqt of the q-axis current component as Iqt1. The value of Idt1 and the value of Iqt1 are, for example, the same. When the first current control is executed, for example, the ECU 90 does not output the heating value target value Cvt, and the heating value target value Cvt is not input to the current calculation unit 51.

The second current control is current control for controlling the three-phase current I to be supplied to the motor 10 when a heating value of the motor 10 is increased more than usual, such as when the warming capacity of the vehicle is insufficient. The second current control is vector control that controls the d-axis current component Id and the q-axis current component Iq of the current I to be supplied to the motor 10 based on the heating value target value Cvt related to the heating value generated in the motor 10. When the second current control is executed, the ECU 90 outputs the heating value target value Cvt, and the heating value target value Cvt is input to the current calculation unit 51.

In the second current control, the control unit 50 sets a ratio of the d-axis current component Id to the q-axis current component Iq to be different from a ratio of the d-axis current component Id to the q-axis current component Iq in the first current control. More specifically, in the second current control, the control unit 50 sets the value of the d-axis current component Id and the value of the q-axis current component Iq to be values at which the energy of the current I to be supplied to the motor 10 is larger than the energy of the current I supplied to the motor 10 in the first current control. As a result, the second current control is executed, and thus, the heating value of the motor 10 becomes larger than when the first current control is executed.

Specifically, in the second current control, the current calculation unit 51 of the control unit 50 calculates, as the target value of each current component, a value at which the product of the value of the d-axis current component Id and the value of the q-axis current component Iq becomes larger than the product in the first current control from among the values of each current component on the equal torque curve of the input torque target value Tt. In other words, in the second current control, the current calculation unit 51 calculates, as the target value of each current component, a value of each current component in which the distance from the origin to the equal torque curve of the torque target value Tt in the graph of FIG. 3 is longer than the distance in the first current control. In the second current control, the current calculation unit 51 sets the calculated value of each current component as a value necessary for setting the heating value of the motor 10 to the heating value target value Cvt.

In the second current control, the current calculation unit 51 calculates the target value of each current component based on, for example, a heating value map in which information regarding the d-axis current component Id and the q-axis current component Iq is stored for the heating value target value Cvt and the torque target value Tt. In the heating value map, the target value of each current component to be set is stored for each combination of the value of the heating value target value Cvt and the value of the torque target value Tt. In the second current control, the current calculation unit 51 selects the target value of each current component corresponding to the input heating value target value Cvt and the torque target value Tt from the heating value map, and outputs the target value to the voltage calculation unit 52.

For example, when the value of the torque target value Tt is T2, in the second current control, the current calculation unit 51 calculates the target value Idt of the d-axis current component as Idt2, and calculates the target value Iqt of the q-axis current component as Iqt2. In the example of FIG. 3, a value of Idt2 is larger than the value of Idt1, and a value of Iqt2 is smaller than the value of Iqt1. The value of Idt2 is larger than the value of Iqt2. As described above, in the present embodiment, the control unit 50 sets the target value Idt of the d-axis current component to be larger than the target value Iqt of the q-axis current component in the second current control.

The second current control is executed, and thus, the heating value of the motor 10 increases. Accordingly, the refrigerant 94 is warmed by the heat of the motor 10. As a result, the air in the vehicle can be suitably warmed by the refrigerant 94. Accordingly, a warming function of the vehicle can be improved by executing the second current control.

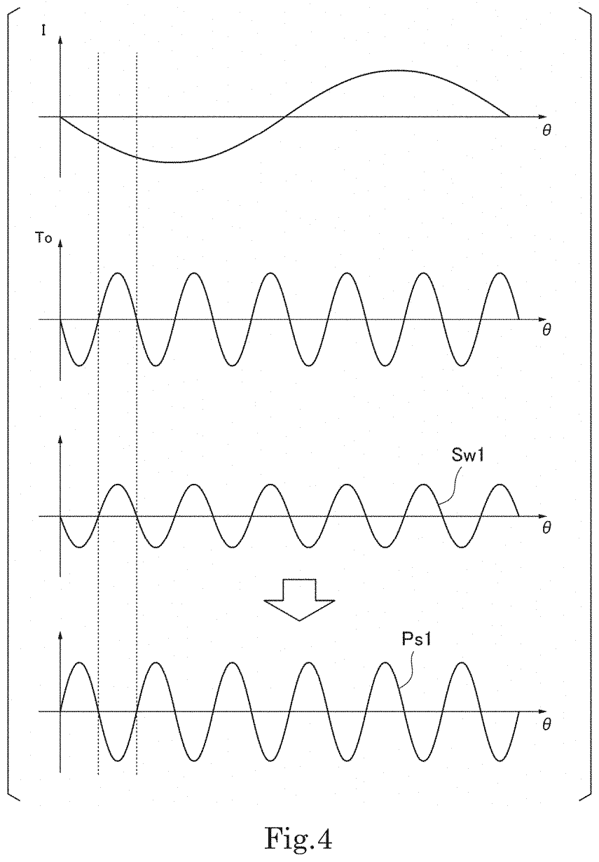

The vibration suppression control is executed when the second current control is executed. The vibration suppression control is control for suppressing vibration caused in the motor 10 when the second current control is executed. FIG. 2 illustrates an input and output relationship of signals in the control unit 50 when the second current control and the vibration suppression control are executed. As illustrated in FIG. 2, in the vibration suppression control, the control unit 50 adds the first periodic signal Ps1 generated by the signal generation unit 54 to the torque target value Tt. As illustrated in FIG. 4, in the present embodiment, the first periodic signal Ps1 is a sine wave signal.

In FIG. 4, four graphs are arranged vertically. An uppermost graph in FIG. 4 is a graph representing an example of a waveform of the current I to be supplied to the motor 10. In the graph, a vertical axis represents the magnitude of the current I, and a horizontal axis represents the electrical angle θ. A second graph from the top in FIG. 4 is a graph representing an example of a waveform of the output torque To of the motor 10 output when the second current control is executed without executing the vibration suppression control. In the graph, a vertical axis represents the magnitude of the output torque To, and a horizontal axis represents the electrical angle θ. In FIG. 4, the waveform of the output torque To is schematically illustrated as a sine wave having a frequency six times the frequency of the waveform of the current I. As described above, when the vibration suppression control is not performed, a variation in the output torque To, that is, a torque ripple, for example, mainly appears in the form of a sixth order for the electrical angle θ of the motor 10. Actually, the waveform of the output torque To includes a torque ripple of another order of a multiple of 6 such as a twelfth order.

A third graph from the top in FIG. 4 illustrates an example of a waveform of a first sine wave Sw1 generated in the signal generation unit 54 based on the electrical angle θ of the motor 10. In the graph, a horizontal axis represents the electrical angle θ. A lowermost graph in FIG. 4 illustrates an example of the waveform of the first periodic signal Ps1 generated by the signal generation unit 54. In the graph, a horizontal axis represents the electrical angle θ.

As illustrated in FIG. 4, a phase of the first periodic signal Ps1 is shifted from a phase of the waveform of the output torque To of the motor 10 output when the second current control is executed without executing the vibration suppression control. In the present embodiment, the phase of the first periodic signal Ps1 is an opposite phase to the phase of the waveform of the output torque To output when the second current control is executed without executing the vibration suppression control.

In the present embodiment, the signal generation unit 54 generates the first sine wave Sw1 based on the electrical angle θ of the motor 10 input from the inverter circuit unit 60. In the present embodiment, the first sine wave Sw1 is a sine wave having a frequency six times the frequency of the waveform of the current I input to the motor 10. The frequency of the first sine wave Sw1 is a frequency similar to a sixth order torque ripple appearing in the output torque To. Here, there is a relationship of ϕ=θ×N/2 between the electrical angle θ of the motor 10 and a mechanical angle ϕ of the motor 10. N is the number of magnetic poles of the motor 10. Thus, the torque ripple that appears at the sixth order with respect to the electrical angle θ appears at a 24th order with respect to the mechanical angle ϕ. The frequency of the first sine wave Sw1 is determined in accordance with the frequency of the torque ripple that appears at the 24th order with respect to the mechanical angle ϕ. When the rotation speed target value of the motor 10 is Rt [rpm], a frequency fs1 of the first sine wave Sw1 is expressed by fs1=Rt×24/60.

The signal generation unit 54 generates the first periodic signal Ps1 from first sine wave Sw1 by modulating the phase of the first sine wave Sw1 based on a first phase map and modulating an amplitude of the first sine wave based on a first amplitude map. That is, the signal generation unit 54 determines the phase of the first periodic signal Ps1 based on the first phase map. The signal generation unit 54 determines an amplitude of the first periodic signal Ps1 based on the first amplitude map.

The first phase map is a control map that stores information regarding the phase of the first periodic signal Ps1 for the rotation speed target value Rt and the torque target value Tt of the motor 10. The information regarding the phase of the first periodic signal Ps1 includes an angle necessary for shifting the phase of the first sine wave Sw1 to the phase of the first periodic signal Ps1. The first amplitude map is a control map that stores information regarding the amplitude of the first periodic signal Ps1 for the rotation speed target value Rt and the torque target value Tt. The information regarding the amplitude of the first periodic signal Ps1 includes a value of the amplitude itself of the first periodic signal Ps1. The first phase map and the first amplitude map can be experimentally obtained, for example. Specifically, the maps can be created by changing the phase and the amplitude of the first periodic signal Ps1 added to the torque target value Tt for each combination of the rotation speed target value Rt and the torque target value Tt and recording parameters when noise actually generated is minimized. Table 1 represents an example of the first phase map, and Table 2 represents an example of the first amplitude map.

TABLE 1
First phase map [°]

| | Rt | | |
|---|---|---|---|
| Tt | 1000 rpm | 2000 rpm | 3000 rpm |
| 0 Nm | 115 | 115 | 120 |
| 10 Nm | 100 | 100 | 105 |
| 20 Nm | 90 | 90 | 90 |
| 30 Nm | 85 | 85 | 90 |

TABLE 2
First amplitude map [Nm]

| | Rt | | |
|---|---|---|---|
| Tt | 1000 rpm | 2000 rpm | 3000 rpm |
| 0 Nm | 5 | 7 | 9 |
| 10 Nm | 5 | 7 | 9 |
| 20 Nm | 5.5 | 8 | 9.5 |
| 30 Nm | 8 | 9 | 10 |

The first phase map represented in Table 1 stores numerical values of an angle [° ] necessary for shifting the phase of the first sine wave Sw1 to the phase of the first periodic signal Ps1. In the first phase map represented in Table 1, numerical values of an angle [° ] corresponding to cases where the torque target value Tt is 0 Nm, 10 Nm, 20 Nm, and 30 Nm are stored for cases where the rotation speed target value Rt is 1000 rpm, 2000 rpm, and 3000 rpm, respectively. For example, when the rotation speed target value Rt is 3000 rpm and the torque target value Tt is 10 Nm, the angle in the first phase map in Table 1 is 105°.

In the first amplitude map represented in Table 2, numerical values of an amplitude [Nm] of the first periodic signal Ps1 are stored. In the first amplitude map represented in Table 2, numerical values of an amplitude [Nm] corresponding to the cases where the torque target value Tt is 0 Nm, 10 Nm, 20 Nm, and 30 Nm are stored for the cases where the rotation speed target value Rt is 1000 rpm, 2000 rpm, and 3000 rpm, respectively. For example, when the rotation speed target value Rt is 1000 rpm and the torque target value Tt is 20 Nm, the angle in the first amplitude map of Table 2 is 5.5 Nm.

The signal generation unit 54 shifts the phase of the first sine wave Sw1 by the angle obtained from the first phase map based on the input rotation speed target value Rt and torque target value Tt, and sets the amplitude of the first sine wave Sw1 to the amplitude obtained from the first amplitude map based on the input rotation speed target value Rt and torque target value Tt. As a result, the first periodic signal Ps1 is generated. The frequency of the first periodic signal Ps1 is the same as the frequency of the first sine wave Sw1. That is, when the frequency of the first periodic signal Ps1 is f1 [Hz] and the rotation speed target value of the motor 10 is Rt [rpm], f1=Rt×24/60 is satisfied.

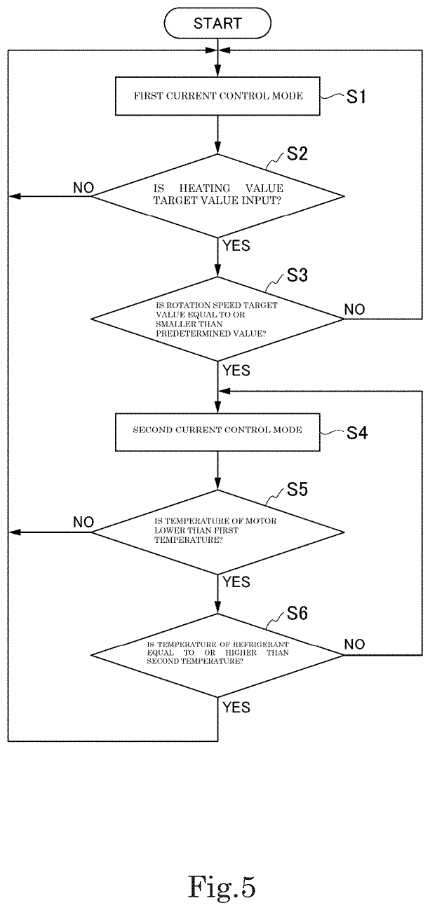

In the present embodiment, the control unit 50 controls the motor 10 according to the flowchart illustrated in FIG. 5. When the control of the motor 10 is started, the control unit 50 controls the motor 10 in a first current control mode (step S1). The first current control mode is a mode in which the first current control is executed. In the first current control mode, the control unit 50 determines whether or not the heating value target value Cvt is input from the ECU 90 (step S2). When the heating value target value Cvt is not input (step S2: NO), the control unit 50 continues to maintain the first current control mode. On the other hand, when the heating value target value Cvt is input (step S2: YES), the control unit 50 determines whether or not the input rotation speed target value Rt is equal to or smaller than a predetermined value (step S3). The predetermined value is, for example, 5000 rpm. When the rotation speed target value Rt is larger than the predetermined value (step S3: NO), the control unit 50 continues to maintain the first current control mode. This is because, when a rotation speed of the motor 10 is larger than the predetermined value, since the energy of the current I to be supplied to the motor 10 becomes sufficiently large, it is not necessary to perform the second current control for increasing the heating value of the motor 10. On the other hand, when the rotation speed target value Rt is equal to or smaller than the predetermined value (step S3: YES), the control unit 50 switches the control mode from the first current control mode to a second current control mode (step S4).

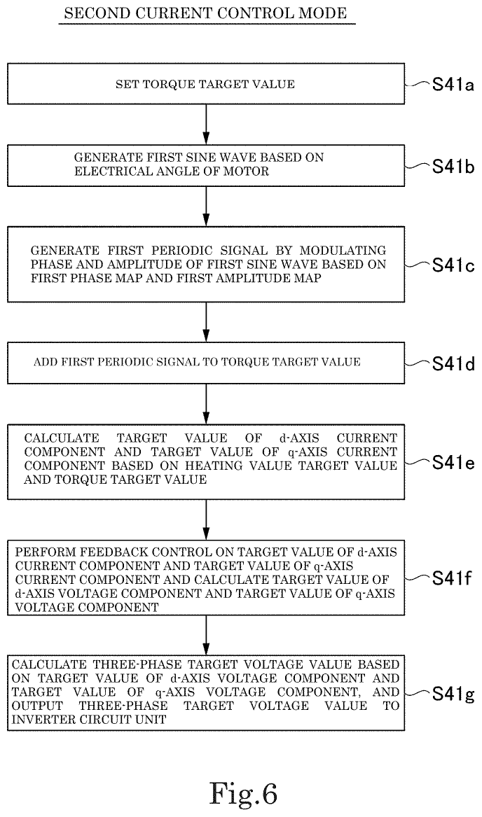

The second current control mode is a mode in which the second current control and the vibration suppression control are executed. In the second current control mode of the present embodiment, the control unit 50 executes the second current control and the vibration suppression control along the flowchart illustrated in FIG. 6. As illustrated in FIG. 6, the control unit 50 that executes the second current control and the vibration suppression control sets the torque target value Tt based on the signal input from the ECU 90 (step S41a). The control unit 50 generates the first sine wave Sw1 based on the electrical angle θ of the motor 10 in the signal generation unit 54 (step S41b). The control unit 50 modulates the phase and amplitude of the first sine wave Sw1 based on the first phase map and the first amplitude map as described above in the signal generation unit 54, and generates the first periodic signal Ps1 (step S41c). The control unit 50 adds the generated first periodic signal Ps1 to the torque target value Tt (step S41d). As a result, a signal obtained by adding the first periodic signal Ps1 to the torque target value Tt output from the ECU 90 is input to the current calculation unit 51.

In the current calculation unit 51, the control unit 50 calculates the target value Idt of the d-axis current component and the target value Iqt of the q-axis current component based on the heating value target value Cvt and the torque target value Tt (step S41e). The control unit 50 performs feedback control on the target value Idt of the d-axis current component and the target value Iqt of the q-axis current component in the voltage calculation unit 52, and calculates the target value Vdt of the d-axis voltage component and the target value Vqt of the q-axis voltage component (step S41f). The control unit 50 calculates the three-phase target voltage values, that is, the target value Vut of the U-phase voltage component, the target value Vvt of the V-phase voltage component, and the target value Vwt of the W-phase voltage component based on the target value Vdt of the d-axis voltage component and the target value Vqt of the q-axis voltage component in the three-phase conversion unit 53, and outputs the three-phase target values to the inverter circuit unit 60 (step S41g). As described above, the control unit 50 executes the second current control and the vibration suppression control in the second current control mode.

As illustrated in FIG. 5, in the second current control mode, the control unit 50 determines whether or not a temperature of the motor 10 is lower than a first temperature based on the detection result of the first temperature sensor 13 (step S5). The first temperature is, for example, equal to or lower than 170° C. When the temperature of the motor 10 is equal to or higher than the first temperature (step S5: NO), the control unit 50 switches the control mode from the second current control mode to the first current control mode (step S1). As a result, the temperature of the motor 10 can be suppressed from becoming excessively high, and the motor 10 can be suppressed from being damaged by heat.

On the other hand, when the temperature of the motor 10 is lower than the first temperature (step S5: YES), the control unit 50 determines whether or not the temperature of the refrigerant 94 is equal to or higher than the second temperature based on the detection result of the second temperature sensor 70 (step S6). The second temperature is, for example, equal to or lower than 30° C. When the temperature of the refrigerant 94 is lower than the second temperature (step S6: NO), the control unit 50 continues to maintain the second current control mode. On the other hand, when the temperature of the refrigerant 94 is equal to or higher than the second temperature (step S6: YES), the control unit 50 switches the control mode from the second current control mode to the first current control mode (step S1). When the temperature of the refrigerant 94 can be set to be equal to or higher than the second temperature, since the air in the vehicle can be suitably warmed, the warming function can be sufficiently obtained. Accordingly, when the temperature of the refrigerant 94 is equal to or higher than the second temperature, the second current control is ended and switched to the first current control, and thus, the power consumption of the motor 10 can be reduced while the warming function is suitably obtained.

In step S2 described above, although the control unit 50 determines whether or not the heating value target value Cvt is input to switch between the first current control mode and the second current control mode, the present invention is not limited thereto. In step S2, the control unit 50 may determine whether or not the temperature of the refrigerant 94 is equal to or higher than the second temperature to switch between the first current control mode and the second current control mode. In this case, in step S2, the control unit 50 continues to maintain the first current control mode when the temperature of the refrigerant 94 is equal to or higher than the second temperature, and switches the control mode from the first current control mode to the second current control mode when the temperature of the refrigerant 94 is lower than the second temperature.

In step S6 described above, although the control unit 50 determines whether or not the temperature of the refrigerant 94 is equal to or higher than the second temperature to switch between the first current control mode and the second current control mode, the present invention is not limited thereto. In step S6, the control unit 50 may determine whether or not the heating value target value Cvt is input to switch between the first current control mode and the second current control mode. In this case, in step S6, the control unit 50 continues to maintain the second current control mode when the heating value target value Cvt is input, and switches the control mode from the second current control mode to the first current control mode when the heating value target value Cvt is input.

When the switching between the first current control mode and the second current control mode is performed based on the temperature of the refrigerant 94, temperature information of the refrigerant 94 may be acquired from the unit other than the second temperature sensor 70 provided in the motor control device 12. For example, the control unit 50 may acquire the temperature information of the refrigerant 94 from the ECU 90, and may switch between the first current control mode and the second current control mode based on the acquired temperature information of the refrigerant 94.

The control unit 50 in the motor control device 12 is a computer that executes the motor control method of the present embodiment described above. A motor control program for causing the control unit 50, which is the computer, to execute the motor control method of the present embodiment is installed in the control unit 50. At least a part of components of the control unit 50 is realized, for example, by a processor such as a CPU executing a motor control program stored in a storage unit (not illustrated).

According to the present embodiment, the control unit 50 can execute the vibration suppression control executed when the second current control is executed, and adds the first periodic signal Ps1 to the torque target value Tt in the vibration suppression control. The phase of the first periodic signal Ps1 is shifted from the phase of the waveform of the output torque To of the motor 10 output when the vibration suppression control is not executed and the second current control is executed. Thus, the waveform of the first periodic signal Ps1 of which the phase is shifted is added to the waveform of the output torque To of the motor 10, and the variation in the output torque To of the motor 10, that is, at least a part of the torque ripple is canceled. As a result, the torque ripple can be reduced, and the vibration of the motor 10 based on the torque ripple can be suppressed. As described above, when control for changing the ratio of the d-axis current component Id to the q-axis current component Iq is performed, the vibration caused in the motor 10 can be suppressed. Accordingly, noise generated from the motor 10 can be reduced. In the present embodiment, it is possible to particularly suitably reduce the 24th order noise caused by the sixth order torque ripple at the electrical angle θ.

For example, the periodic signal of which the phase is shifted from the waveform of each value output when the second current control is executed without executing the vibration suppression control is added to at least one of the target value Idt of the d-axis current component, the target value Iqt of the q-axis current component, the target value Vdt of the d-axis voltage component, and the target value Vqt of the q-axis voltage component, and thus, it is also possible to reduce the torque ripple and suppress the vibration of the motor 10. However, a vibration suppression effect obtained by adding the periodic signal of which the phase is shifted to one of these target values is smaller than a vibration suppression effect when the first periodic signal Ps1 is added to the torque target value Tt as in the present embodiment, and relatively large vibration caused in the motor 10 when the second current control is performed cannot be sufficiently suppressed. When the periodic signal of which the phase is shifted is added to two or more of these target values, there is a possibility that the vibration suppression effect is improved. However, in this case, it is necessary to determine the parameter of each periodic signal in consideration of the influence of changes in other target values, and there is a problem that it is difficult to determine a suitable parameter.

On the other hand, in the present embodiment, the first periodic signal Ps1 is added to the torque target value Tt, and thus, it is possible to obtain the large vibration suppression effect as compared with the case where the periodic signal of which the phase is shifted to one of the target value of each current component and the target value of each voltage component. Thus, the vibration of the motor 10 can be suitably suppressed when the second current control is performed while the parameter of the first periodic signal Ps1 to be added is easily determined.

According to the present embodiment, the phase of the first periodic signal Ps1 is the opposite phase to the phase of the waveform of the output torque To output when the second current control is executed without executing the vibration suppression control. Thus, the vibration suppression control is executed, and thus, the waveform of the first periodic signal Ps1 having the opposite phase is added to the waveform of the output torque To of the motor 10. Accordingly, the variation in the output torque To of the motor 10, that is, the torque ripple is more suitably canceled. As a result, the torque ripple can be further reduced, and the vibration of the motor 10 based on the torque ripple can be further suppressed. Accordingly, the noise generated from the motor 10 can be further reduced.

According to the present embodiment, the control unit 50 includes the signal generation unit 54 that generates the first periodic signal Ps1. The signal generation unit 54 determines the phase of the first periodic signal Ps1 based on the first phase map in which the information regarding the phase of the first periodic signal Ps1 is stored for the rotation speed target value Rt and the torque target value Tt of the motor 10, and determines the amplitude of the first periodic signal Ps1 based on the first amplitude map in which the information regarding the amplitude of the first periodic signal Ps1 is stored for the rotation speed target value Rt and the torque target value Tt. Thus, the first periodic signal Ps1 can suitably and easily be generated.

According to the present embodiment, the signal generation unit 54 generates the first sine wave Sw1 based on the electrical angle θ of the motor 10, and generates the first periodic signal Ps1 from the first sine wave Sw1 by modulating the phase of the first sine wave Sw1 based on the first phase map and modulating the amplitude of the first sine wave Sw1 based on the first amplitude map. Thus, it is possible to easily generate the first periodic signal Ps1 in which the phase and the amplitude are suitably adjusted with respect to the torque ripple appearing in the output torque To of the motor 10.

According to the present embodiment, when the frequency of the first periodic signal Ps1 is f1 [Hz] and the rotation speed target value of the motor 10 is Rt [rpm], f1=Rt×24/60 is satisfied. As described above, the torque ripple appearing in the output torque To of the 8-pole motor 10 mainly appears in the form of the 24th order. Thus, the frequency of the first periodic signal Ps1 is set to a value that satisfies the above Expression, and thus, the frequency of the first periodic signal Ps1 and the frequency of the torque ripple that mainly appears can be similar. As a result, the torque ripple can be more suitably reduced by adding the first periodic signal Ps1 of which the phase is shifted to the torque target value Tt. Accordingly, the vibration of the motor 10 based on the torque ripple can be further suppressed, and the noise generated from the motor 10 can be further reduced.

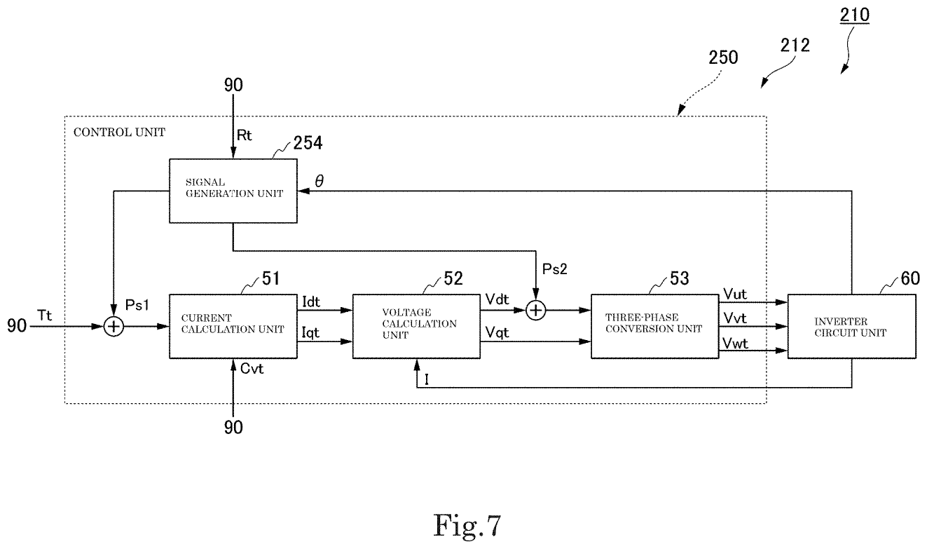

As illustrated in FIG. 7, in a motor control device 212 of a motor 210 according to the present embodiment, a signal generation unit 254 of a control unit 250 generates a second periodic signal Ps2 in addition to the first periodic signal Ps1. In the vibration suppression control, the control unit 250 adds the second periodic signal Ps2 to the target value of at least one voltage component of the d-axis voltage component and the q-axis voltage component calculated by the voltage calculation unit 52. In the present embodiment, in the vibration suppression control, the control unit 250 adds the second periodic signal Ps2 to the target value Vdt of the d-axis voltage component output from the voltage calculation unit 52.

Although not illustrated, in the present embodiment, the second periodic signal Ps2 is a sine wave signal similarly to the first periodic signal Ps1. A phase of the second periodic signal Ps2 is shifted from the phase of the waveform of the d-axis voltage component output when the vibration suppression control is executed without adding the second periodic signal Ps2 to the target value Vdt of the d-axis voltage component. The waveform of the d-axis voltage component output when the vibration suppression control is executed without adding the second periodic signal Ps2 to the target value Vdt of the d-axis voltage component corresponds to the waveform of the d-axis voltage component output when the vibration suppression control is executed in the first embodiment described above. In the present embodiment, the phase of the second periodic signal Ps2 is an opposite phase to the phase of the waveform of the d-axis voltage component output when the vibration suppression control is executed without adding the second periodic signal Ps2 to the target value Vdt of the d-axis voltage component.

In the present embodiment, the signal generation unit 254 generates a second sine wave based on an electrical angle θ of the motor 210 input from the inverter circuit unit 60. In the present embodiment, the second sine wave is a sine wave having a frequency 12 times a frequency of a waveform of a current I input to the motor 210. The frequency of the second sine wave is a frequency similar to the torque ripple appearing at the twelfth order with respect to the electrical angle θ, that is, the torque ripple appearing at the 48th order with respect to the mechanical angle ϕ. When a rotation speed target value of the motor 210 is Rt [rpm], a frequency fs2 of the second sine wave is expressed by fs2=Rt×48/60.

The signal generation unit 254 generates the second periodic signal Ps2 from the second sine wave by modulating a phase of the second sine wave based on a second phase map and modulating an amplitude of the second sine wave based on a second amplitude map. That is, the signal generation unit 254 determines the phase of the second periodic signal Ps2 based on the second phase map. The signal generation unit 254 determines the amplitude of the second periodic signal Ps2 based on the second amplitude map.

The second phase map is a control map that stores information regarding the phase of the second periodic signal Ps2 for a rotation speed target value Rt and a torque target value Tt of the motor 210. The information regarding the phase of the second periodic signal Ps2 includes an angle necessary for shifting the phase of the second sine wave to the phase of the second periodic signal Ps2. The second amplitude map is a control map that stores information regarding the amplitude of the second periodic signal Ps2 for the rotation speed target value Rt and the torque target value Tt. The information regarding the amplitude of the second periodic signal Ps2 includes a value of the amplitude itself of the second periodic signal Ps2. The second phase map is similar to the first phase map except that the second phase map is a control map for the second periodic signal Ps2. The second amplitude map is similar to the second amplitude map except that the second amplitude map is a control map for the second periodic signal Ps2.

The second phase map and the second amplitude map can be experimentally obtained, for example. Specifically, in a state where the first periodic signal Ps1 is added to the torque target value Tt, the maps can be created by changing the phase and the amplitude of the second periodic signal Ps2 added to the target value Vdt of the d-axis voltage component for each combination of the rotation speed target value Rt and the torque target value Tt and recording parameters when noise actually generated is minimized.

The signal generation unit 254 shifts the phase of the second sine wave by the angle obtained from the second phase map based on the input rotation speed target value Rt and torque target value Tt, and sets the amplitude of the second sine wave to the amplitude obtained from the second amplitude map based on the input rotation speed target value Rt and torque target value Tt. As a result, the second periodic signal Ps2 is generated. The frequency of the second periodic signal Ps2 is the same as the frequency of the second sine wave. That is, when the frequency of the second periodic signal Ps2 is f2 [Hz] and the rotation speed target value of the motor 210 is Rt [rpm], f2=Rt×48/60 is satisfied.

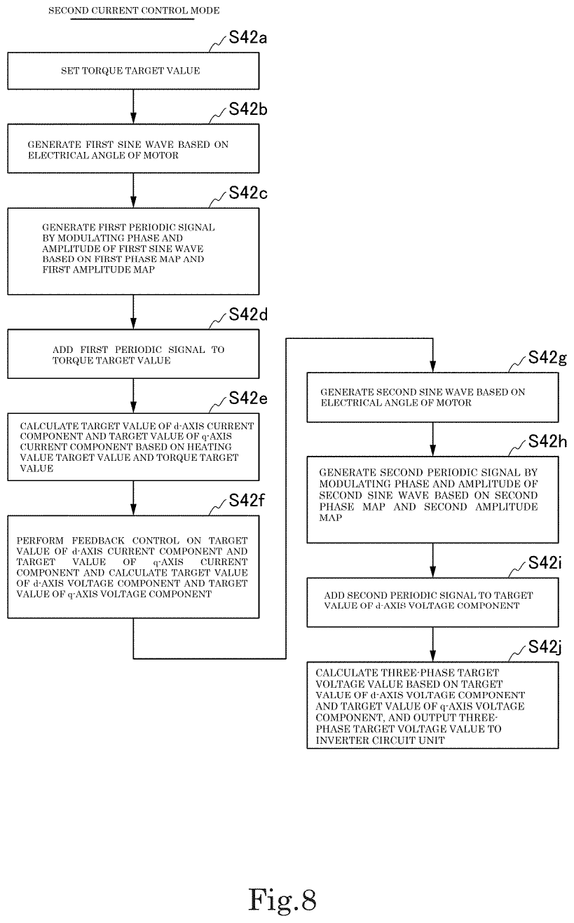

In the second current control mode of the present embodiment, the control unit 250 executes the second current control and the vibration suppression control along the flowchart illustrated in FIG. 8. Steps S42a to S42f illustrated in FIG. 8 are similar to steps S41a to S41f illustrated in FIG. 6. The control unit 250 generates the second sine wave based on the electrical angle θ of the motor 210 in the signal generation unit 254 (step S42g). As described above, the control unit 250 modulates the phase and amplitude of the second sine wave based on the second phase map and the second amplitude map in the signal generation unit 254, and generates the second periodic signal Ps2 (step S42h). The control unit 250 adds the generated second periodic signal Ps2 to the target value Vdt of the d-axis voltage component (step S42i). As a result, a signal obtained by adding the second periodic signal Ps2 to the target value Vdt of the d-axis voltage component output from the voltage calculation unit 52 is input to the three-phase conversion unit 53. Step S42j illustrated in FIG. 8 is similar to step S41g illustrated in FIG. 6. As described above, the control unit 250 executes the second current control and the vibration suppression control in the second current control mode. Other control procedures of the control unit 250 are similar to the other control procedures of the control unit 50 of the first embodiment.

The control unit 250 in the motor control device 212 is a computer that executes the motor control method of the present embodiment described above. A motor control program for causing the control unit 250, which is the computer, to execute the motor control method of the present embodiment is installed in the control unit 250. Other configurations of the motor control device 212 are similar to the other configurations of the motor control device 12 of the first embodiment. Other configurations of the motor 210 are similar to the other configurations of the motor 10 of the first embodiment.

According to the present embodiment, in the vibration suppression control, the control unit 250 adds the second periodic signal Ps2 to the target value of at least one voltage component of the d-axis voltage component and the q-axis voltage component calculated by the voltage calculation unit 52. The phase of the second periodic signal Ps2 is shifted from the phase of the waveform of the one voltage component output when the vibration suppression control is executed without adding the second periodic signal Ps2 to the target value of the one voltage component. In the present embodiment, the one voltage component is the d-axis voltage component. Thus, the waveform of the second periodic signal Ps2 of which the phase is shifted is added to the waveform of the d-axis voltage component, and at least a part of variations in the d-axis voltage component is canceled. As a result, a variation in an output torque To of the motor 210 output based on the d-axis voltage component and the q-axis voltage component, that is, a torque ripple can be further reduced. That is, the torque ripple reduced by adding the first periodic signal Ps1 to the torque target value Tt can be further reduced by adding the second periodic signal Ps2 to the target value Vdt of the d-axis voltage component. Specifically, for example, a torque ripple of an order different from the order of the torque ripple that can be reduced by adding the first periodic signal Ps1 to the torque target value Tt can be reduced by adding the second periodic signal Ps2 to the target value Vdt of the d-axis voltage component. Accordingly, when control for changing the ratio of the d-axis current component to the q-axis current component is performed, the vibration caused in the motor 210 can be further suppressed. Thus, the noise generated from the motor 210 can be further reduced. In the present embodiment, the 24th order noise can be reduced by adding the first periodic signal Ps1, and the 48th order noise can be reduced by adding the second periodic signal Ps2.

According to the present embodiment, the phase of the second periodic signal Ps2 is the opposite phase to the phase of the waveform of the d-axis voltage component output when the vibration suppression control is executed without adding the second periodic signal Ps2 to the target value Vdt of the d-axis voltage component. Thus, the vibration suppression control is executed, and thus, the waveform of the second periodic signal Ps2 having the opposite phase is added to the waveform of the d-axis voltage component. Accordingly, the variation in the output torque To of the motor 210, that is, the torque ripple is more suitably canceled. As a result, the torque ripple can be further reduced, and the vibration of the motor 210 based on the torque ripple can be further suppressed. Accordingly, the noise generated from the motor 210 can be further reduced. In particular, the 48th order noise can be further suppressed by the addition of the second periodic signal Ps2.

According to the present embodiment, in the second current control, the control unit 250 sets the target value Idt of the d-axis current component to be larger than the target value Iqt of the q-axis current component. Thus, the influence of the d-axis component on the waveform of the output torque To is larger than the influence of the q-axis component on the waveform of the output torque To. In the vibration suppression control, the control unit 250 adds the second periodic signal Ps2 to the target value Vdt of the d-axis voltage component. Thus, it is possible to suitably suppress the variation in the d-axis component having a relatively large influence on the waveform of the output torque To. As a result, the vibration of the motor 210 can be more suitably suppressed.

According to the present embodiment, the signal generation unit 254 determines the phase of the second periodic signal Ps2 based on the second phase map in which the information regarding the phase of the second periodic signal Ps2 is stored for the rotation speed target value Rt and the torque target value Tt of the motor 210, and determines the amplitude of the second periodic signal Ps2 based on the second amplitude map in which the information regarding the amplitude of the second periodic signal Ps2 is stored for the rotation speed target value Rt and the torque target value Tt. Thus, the second periodic signal Ps2 can suitably and easily be generated.

According to the present embodiment, the signal generation unit 254 generates the second sine wave based on the electrical angle θ of the motor 210, and generates the second periodic signal Ps2 from the second sine wave by modulating the phase of the second sine wave based on the second phase map and modulating the amplitude of the second sine wave based on the second amplitude map. Thus, the second periodic signal Ps2 of which the phase and the amplitude are suitably adjusted can be easily generated.

According to the present embodiment, when the frequency of the second periodic signal Ps2 is f2 [Hz] and the rotation speed target value of the motor 210 is Rt [rpm], f2=Rt×48/60 is satisfied. As described above, the torque ripple appearing in the output torque To of the 8-pole motor 210 includes a 48th order component and the like in addition to the 24th order component. Thus, the frequency of the second periodic signal Ps2 is set to a value that satisfies the above Expression, and thus, the frequency of the second periodic signal Ps2 and the frequency of the 48th order torque ripple can be similar. As a result, the torque ripple of the 48th order can be more suitably reduced by adding the second periodic signal Ps2 of which the phase is shifted to the target value Vdt of the d-axis voltage component. Accordingly, the vibration of the motor 210 based on the torque ripple can be further suppressed, and the noise generated from the motor 210 can be further reduced.

For example, at least a part of the functions in the components of the control unit according to the first embodiment and the second embodiment is realized by a processor such as a central processing unit (CPU) executing a motor control program stored in a storage unit (not illustrated), that is, software. For example, at least a part of the functions of the components of the control unit may be realized by hardware including a circuit unit such as a large scale integration (LSI), an application specific integrated circuit (ASIC), a field-programmable gate array (FPGA), and a graphics processing unit (GPU), or may be realized by cooperation of software and hardware. The storage unit (not illustrated) is realized by a storage medium such as a random access memory (RAM), a read only memory (ROM), a hard disk drive (HDD), and a flash memory.

The present invention is not limited to the above-described embodiments, and other configurations and methods can be adopted within the scope of the technical idea of the present invention. Conditions and timings in which the first current control and the second current control are executed are not particularly limited. The second current control may be executed when a battery mounted on the motor or the drive apparatus is warmed. The second current control is performed to warm the battery by the heat of the motor, and thus, it is possible to suppress a decrease in a charging speed of the battery. Accordingly, it is possible to easily take out electric power from the battery. In the second current control, the value of the q-axis current component may be set to be larger than the value of the d-axis current component.

The phase of the first periodic signal may be any phase as long as the phase is shifted from the phase of the waveform of the output torque of the motor output when the second current control is executed without executing the vibration suppression control. The phase of the second periodic signal may be any phase as long as the phase is shifted from the phase of the waveform of one voltage component output when the vibration suppression control is executed without adding the second periodic signal to the target value of the one voltage component. The second periodic signal may be added to the target value of the q-axis voltage component, or may be added to the target value of the d-axis voltage component and the target value of the q-axis voltage component. The configurations and the methods described above in the present description can be combined as appropriate within a scope in which no mutual contradiction arises.

### EXAMPLES

Effects of the first embodiment and the second embodiment described above were verified. The magnitude of the noise generated from the motor was compared with the magnitude of the noise generated when the vibration suppression control was not performed, for each case when the vibration suppression control of the first embodiment was performed and when the vibration suppression control of the second embodiment was performed on the motor similar to each embodiment. The comparison was performed for each vibration suppression control when the torque target value Tt was 0 Nm, 20 Nm, and 50 Nm for the rotation speed target values Rt of the motor which were 500 rpm, 1000 rpm, 2000 rpm, and 3000 rpm.

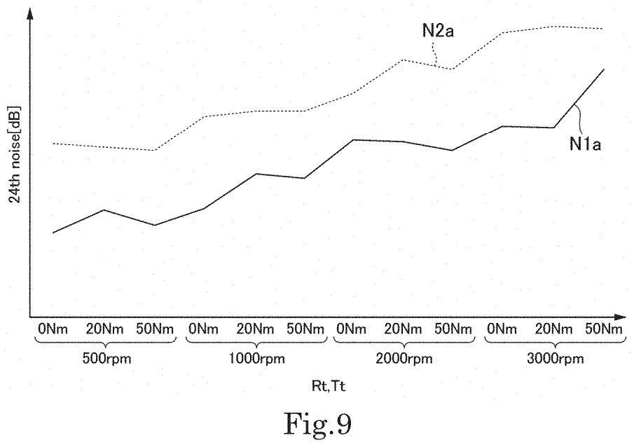

FIG. 9 is a graph representing a result when the vibration suppression control of the first embodiment is performed. In FIG. 9, a vertical axis represents the magnitude [dB] of the 24th order noise. Noise N1a indicated by a solid line in FIG. 9 is noise when the vibration suppression control of the first embodiment is performed, and noise N2a indicated by a broken line in FIG. 9 is noise when the vibration suppression control is not performed. As illustrated in FIG. 9, it has been confirmed that the 24th order noise can be suitably reduced in any combination of the rotation speed target value Rt and the torque target value Tt by performing the vibration suppression control according to the first embodiment as compared with the case where the vibration suppression control is not performed. A difference between the noise Nia and the noise N2a was about 20 dB.

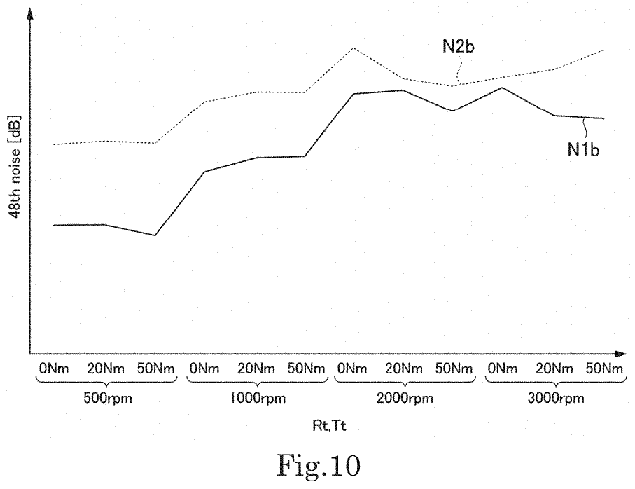

In FIG. 10, a vertical axis represents the magnitude [dB] of the 48th order noise. FIG. 10 is a graph representing a result when the vibration suppression control of the second embodiment is performed. Noise Nib indicated by a solid line in FIG. 10 is noise when the vibration suppression control of the second embodiment is performed, and noise N2b indicated by a broken line in FIG. 10 is noise when the vibration suppression control is not performed. As illustrated in FIG. 10, it has been confirmed that the noise of the 48th order can be reduced in any combination of the rotation speed target value Rt and the torque target value Tt by performing the vibration suppression control of the second embodiment as compared with the case where the vibration suppression control is not performed. A difference between the noise Nib and the noise N2b was equal to or larger than about 5 dB and equal to or smaller than 20 dB. Although not illustrated, it has been confirmed that the 24th order noise when the vibration suppression control of the second embodiment is performed can be reduced similarly to the case where the vibration suppression control of the first embodiment illustrated in FIG. 9 is performed.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor control device comprising:
a control unit that controls a motor based on a torque target value,
wherein the control unit is capable of executing
first current control for controlling a d-axis current component and a q-axis current component of a current to be supplied to the motor,
second current control for controlling the d-axis current component and the q-axis current component based on a heating value target value related to a heating value generated in the motor and setting a ratio of the d-axis current component to the q-axis current component to be different from the ratio in the first current control, and
vibration suppression control to be executed when the second current control is executed, and
adds a first periodic signal to the torque target value in the vibration suppression control, and
a phase of the first periodic signal is shifted from a phase in a waveform of an output torque of the motor output when the second current control is executed without executing the vibration suppression control.

2. The motor control device according to claim 1, wherein the phase of the first periodic signal is an opposite phase to the phase in the waveform of the output torque output when the second current control is executed without executing the vibration suppression control.

3. The motor control device according to claim 1, wherein
the control unit includes a signal generation unit that generates the first periodic signal, and
the signal generation unit
determines the phase of the first periodic signal based on a first phase map in which information regarding the phase of the first periodic signal is stored for a rotation speed target value and the torque target value of the motor, and
determines an amplitude of the first periodic signal based on a first amplitude map in which information regarding an amplitude of the first periodic signal is stored for the rotation speed target value and the torque target value.

4. The motor control device according to claim 3, wherein
the signal generation unit
generates a first sine wave based on an electrical angle of the motor, and
generates the first periodic signal from the first sine wave by modulating a phase of the first sine wave based on the first phase map and modulating an amplitude of the first sine wave based on the first amplitude map.

5. The motor control device according to claim 1, wherein, when a frequency of the first periodic signal is f1 [Hz] and a rotation speed target value of the motor is Rt [rpm], f1=Rt×24/60 is satisfied.

6. The motor control device according to claim 1, wherein
the control unit includes
a current calculation unit that calculates a target value of the d-axis current component and a target value of the q-axis current component, and
a voltage calculation unit that calculates a target value of a d-axis voltage component and a target value of a q-axis voltage component based on the target value of the d-axis current component and the target value of the q-axis current component calculated by the current calculation unit,
adds a second periodic signal to the target value of at least one voltage component of the d-axis voltage component and the q-axis voltage component calculated by the voltage calculation unit in the vibration suppression control, and
a phase of the second periodic signal is shifted from a phase in a waveform of the one voltage component output when the vibration suppression control is executed without adding the second periodic signal to the target value of the one voltage component.

7. The motor control device according to claim 6, wherein the phase of the second periodic signal is an opposite phase to the phase in the waveform of the one voltage component output when the vibration suppression control is executed without adding the second periodic signal to the target value of the one voltage component.

8. The motor control device according to claim 6, wherein
the control unit
sets the target value of the d-axis current component to be larger than the target value of the q-axis current component in the second current control, and
adds the second periodic signal to the target value of the d-axis voltage component in the vibration suppression control.

9. The motor control device according to claim 6, wherein
the control unit includes a signal generation unit that generates the second periodic signal, and
the signal generation unit
determines the phase of the second periodic signal based on a second phase map in which information regarding the phase of the second periodic signal is stored for a rotation speed target value and the torque target value of the motor, and
determines an amplitude of the second periodic signal based on a second amplitude map in which information regarding the amplitude of the second periodic signal is stored for the rotation speed target value and the torque target value.

10. The motor control device according to claim 9, wherein
the signal generation unit
generates a second sine wave based on an electrical angle of the motor, and
generates the second periodic signal from the second sine wave by modulating a phase of the second sine wave based on the second phase map and modulating an amplitude of the second sine wave based on the second amplitude map.

11. The motor control device according to claim 8, wherein a frequency of the second periodic signal is f2 [Hz] and a rotation speed target value of the motor is Rt [rpm], f2=Rt×48/60 is satisfied.

12. A motor comprising the motor control device according to claim 1.

13. A drive apparatus that rotates an axle of a vehicle, comprising:
the motor according to claim 12; and
a transmission mechanism that transmits rotation of the motor to the axle.

14. A motor control method for controlling a motor based on a torque target value, comprising:
executing first current control for controlling a d-axis current component and a q-axis current component of a current to be supplied to the motor;
executing second current control for controlling the d-axis current component and the q-axis current component based on a heating value target value related to a heating value generated in the motor and setting a ratio of the d-axis current component to the q-axis current component to be different from the ratio in the first current control;
executing vibration suppression control to be executed when the second current control is executed; and
adding a first periodic signal to the torque target value in the vibration suppression control,
wherein a phase of the first periodic signal is shifted from a phase in a waveform of an output torque of the motor output when the second current control is executed without executing the vibration suppression control.

15. The motor control method according to claim 14, wherein the phase of the first periodic signal is an opposite phase to the phase in the waveform of the output torque output when the second current control is executed without executing the vibration suppression control.

16. The motor control method according to claim 14, further comprising:
calculating a target value of the d-axis current component and a target value of the q-axis current component;
calculating a target value of a d-axis voltage component and a target value of a q-axis voltage component based on the target value of the d-axis current component and the target value of the q-axis current component; and
adding a second periodic signal to the calculated target value of at least one voltage component of the d-axis voltage component and the q-axis voltage component in the vibration suppression control,
wherein a phase of the second periodic signal is shifted from a phase in a waveform of the one voltage component output when the vibration suppression control is executed without adding the second periodic signal to the target value of the one voltage component.

17. The motor control method according to claim 16, wherein the phase of the second periodic signal is an opposite phase to the phase in the waveform of the one voltage component output when the vibration suppression control is executed without adding the second periodic signal to the target value of the one voltage component.

18. The motor control method according to claim 16, wherein
the target value of the d-axis current component is set to be larger than the target value of the q-axis current component in the second current control, and
the second periodic signal is added to the target value of the d-axis voltage component in the vibration suppression control.

19. The motor control method according to claim 16, wherein a frequency of the first periodic signal is f1 [Hz], a frequency of the second periodic signal is f2 [Hz], and a rotation speed target value of the motor is Rt [rpm], f1=Rt×24/60 and f2=Rt×48/60 are satisfied.

20. A recording medium recording a motor control program causing a computer to execute the motor control method according to claim 14.
